(19) United States
(12) Patent Application Publication
(10) Pub. No.: US 2012/0099448 A1
(43) Pub. Date: Apr. 26, 2012

(54) WIRELESS COMMUNICATION METHOD AND WIRELESS APPARATUS

(75) Inventors: Ryoko Matsuo, Tokyo (JP); Tomoya Tandai, Kanagawa-ken (JP); Takeshi Tomizawa, Kanagawa-ken (JP)

(73) Assignee: KABUSHIKI KAISHA TOSHIBA, Tokyo (JP)

(21) Appl. No.: 13/224,490

(22) Filed: Sep. 2, 2011

(30) Foreign Application Priority Data
Oct. 22, 2010 (JP) P2010-237404

(51) Int. Cl. H04W 84/02; H04W 24/00

(52) U.S. Cl. 370/252; 370/338

(57) ABSTRACT

A wireless apparatus includes: a first wireless unit, a second wireless unit, a controller, and a processing unit. The first wireless unit performs wireless communications in a first communication mode for performing the communications within a first communication coverage area. The second wireless unit performs wireless communications in a second communication mode for performing the communications within a second communication coverage area which is smaller than the first communication coverage area. The controller starts the second wireless unit on the basis of a received power of the start notification signal. The start notification signal is received by the first wireless unit. The processing unit manages or holds data transmitted and received by the first wireless unit and the second wireless unit.

### CROSS-REFERENCE TO RELATED APPLICATION

This application is based upon and claims the benefit of priority from Japanese Patent Application No. P2010-237404, filed on Oct. 22, 2010; the entire contents of which are incorporated herein by reference.

### FIELD

Embodiments of the invention are generally related with a wireless communication technology.

### BACKGROUND

Wireless communication apparatuses (hereinafter simply referred to as wireless apparatuses) each supporting various communication modes, such as a cellular, wireless LAN, and RFID (Radio Frequency Identification) communication modes, are widely used. For instance, some cellular telephones support both the cellular communication mode covering a broader communication coverage area and the wireless LAN communication mode whose communication coverage area is smaller than that of the cellular communication mode. Many of recently-released PCs (Personal Computers) support multiple communication modes, such as the wireless LAN and RFID communication modes, which are different from each other in communication coverage.

For a single wireless apparatus is made to support multiple communication modes as described above, studies have been made on a technique for reducing electric power consumed by a wireless unit adopting one of the multiple communication modes.

The conventional wireless apparatus achieves a lower power consumption of the wireless LAN by using Bluetooth to exchange information concerning whether or not there is a wireless LAN interface or whether or not to turn on/off the wireless LAN function.

### BRIEF DESCRIPTION OF THE DRAWINGS

FIG. 1 is a diagram showing a system configuration of a first embodiment.

FIG. 2 is a diagram showing a configuration of a first wireless apparatus 1 of the first embodiment.

FIG. 3 is a diagram showing an operation of a wireless system relating with the first embodiment.

FIG. 4 is a diagram showing an operation of the first wireless apparatus 1 relating with the first embodiment.

FIG. 5 is a diagram showing an operation of a second wireless apparatus 2 relating with the first embodiment.

FIG. 6 is a diagram showing an operation of a first wireless apparatus 1 relating with a second embodiment.

FIG. 7 is a diagram showing an operation of a second wireless apparatus 2 relating with the second embodiment.

FIG. 8 is a diagram showing an operation of a wireless system relating with a third embodiment.

FIG. 9 is a diagram showing an operation of a first wireless apparatus 1 relating with the third embodiment.

FIG. 10 is a diagram showing a configuration of a first wireless apparatus 11 of a fourth embodiment.

FIG. 11 is a diagram showing an operation of the first wireless apparatus 11 relating with the fourth embodiment.

FIG. 12 is a diagram showing an operation of a second wireless apparatus 12 relating with the fourth embodiment.

FIG. 13 is a diagram showing an operation of a first wireless apparatus 1 relating with a fifth embodiment.

### DETAILED DESCRIPTION

To reduce the power consumption of the wireless unit (wireless LAN) configured to perform communications in a communication mode covering a broader communication coverage area, the conventional technology is to enable communications using a wireless unit (Bluetooth) configured to perform communications in a communication mode covering a smaller communication coverage than that of the wireless unit (wireless LAN). The technology, however, pays no attention to the power consumption of the wireless unit configured to perform communications in the communication mode covering the smaller coverage area.

An aspect of one embodiment is to provide a wireless apparatus supporting multiple communication modes with the respective different communication coverage areas, which is capable of reducing power consumption of the wireless unit configured to perform communications in the smaller communication coverage area.

In view of the above circumstances it is provide that, a wireless apparatus of an embodiment includes: a first wireless unit configured to perform wireless communications in a first communication mode for performing the communications within a first communication coverage area, and to receive a start notification signal transmitted in accordance with the first communication mode; a second wireless unit configured to perform wireless communications in a second communication mode for performing the communications within a second communication coverage area which is smaller than the first communication coverage area; a controller configured to start the second wireless unit on the basis of a received power of the start notification signal; and a processing unit configured to manage or hold data transmitted and received by the first wireless unit and the second wireless unit.

### First Embodiment

A first embodiment will be described in detail below by referring to the drawings.

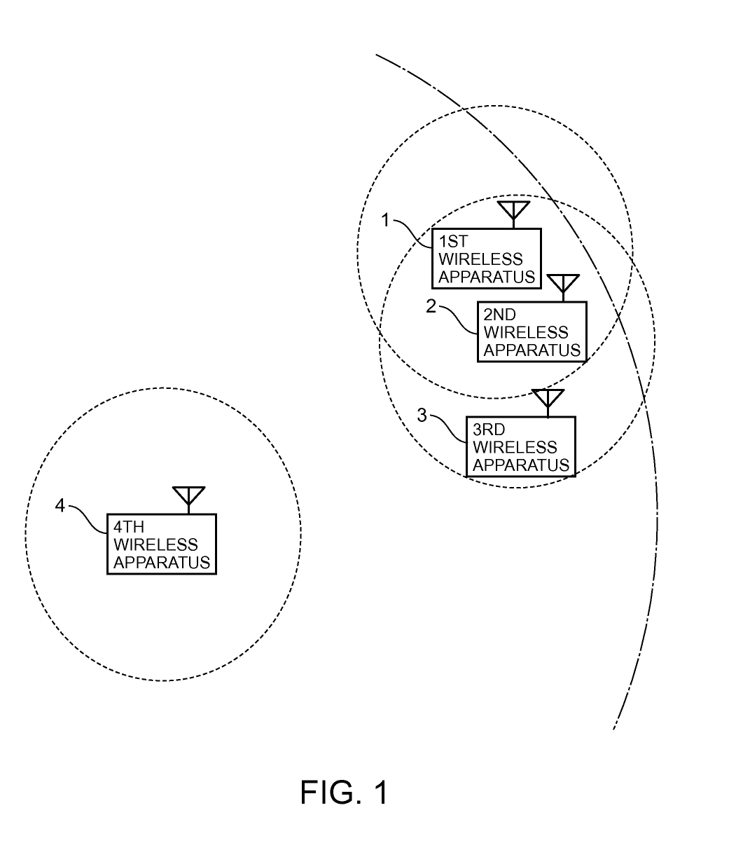

Firstly, an overall description of a wireless system of this embodiment will be described by use of FIG. 1. The wireless system shown in FIG. 1 includes first to fourth wireless apparatuses 1 to 4. The first to fourth wireless apparatuses 1 to 4 communicate with one another using both a first communication mode for performing communications within a first communication coverage area and a second communication mode for performing communications in a second communication coverage area smaller than the first communication coverage area. The first communication mode is, for instance, a wireless LAN communication mode, and the first communication coverage area has a diameter of several meters.

The second communication mode is a communication mode using, for instance, a millimeter wave band. The second communication coverage area of this embodiment has a diameter of approximately several tens of centimeters at most. Two of the first to fourth wireless apparatus 1 to 4 perform one-to-one short distance communications. The second communication mode can perform faster, larger-capacity communications than the first communication mode.

The one-to-one short distance communications are expected to carry out a scheme that establishes a connection more easily and efficiently than a scheme in which more emphasis is put on interference avoidance and fair use of wireless bands like in wireless LAN communications; and in which one of wireless apparatuses as an access point transmits a broadcast signal (for example, a beacon signal); and each wireless apparatus performs random back-off control every transmission. In one conceivable example of the expected scheme, when a frame transmission is to be performed, control signals such as a connect request signal and a connect accept signal are exchanged among the wireless apparatuses in order to start a connection; and once the connection is established, the transmitting of a transmission signal and the receiving of an acknowledgement signal (denoted by reference sign ACK or Block ACK (hereinafter shortened to BK)) are alternately repeated at short constant intervals, such as SIFS (short inter-frame spaces).

The wireless system of the case shown in FIG. 1 includes four wireless apparatuses, but the number of the wireless apparatuses is not limited to the four. Two to five wireless apparatuses may be used.

In FIG. 1, the second communication coverage areas of the first to fourth wireless apparatus 1 to 4 are indicated with dashed lines. Each of the first wireless apparatus 1 and the second wireless apparatus 2 exists in the other's second communication coverage area. Accordingly, the first wireless apparatus 1 and the second wireless apparatus 2 may communicate with each other using the second communication mode or may use the first communication mode.

The dashed-dotted line in FIG. 1 indicates the first communication coverage area of the fourth wireless apparatus 4. Since neither the first wireless apparatus 1 nor the second wireless apparatus 2 exists in the second communication coverage area of the fourth wireless apparatus 4, the fourth wireless apparatus 4 cannot communicate with the first wireless apparatus 1 or the second wireless apparatus 2 in the second communication mode. Since, however, both of the first and second wireless apparatuses 1, 2 exist in the first communication coverage area of the fourth wireless apparatus 4, the fourth wireless apparatus 4 can communicate with the first and second wireless apparatuses 1, 2 in the first communication mode. Though not illustrated in FIG. 1, it goes without saying that all of the first to fourth wireless apparatuses 1 to 4 exist in the first communication coverage area of each of the first to the third wireless apparatuses 1 to 3.

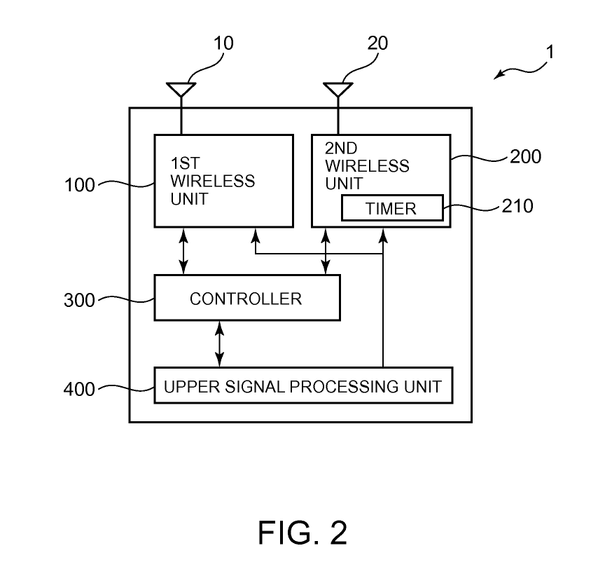

The configuration of the wireless apparatuses of the first embodiment will be described by referring to FIG. 2. Since all of the first to fourth wireless apparatuses 1 to 4 are identical to one another, the following description will be provided for the first wireless apparatus 1.

The first wireless apparatus 1 shown in FIG. 2 includes a first wireless unit 100, a second wireless unit 200, a controller 300, and a processing unit (upper signal processing unit) 400. The first wireless unit 100 performs wireless communications in the first communication mode for performing the communications in the first communication coverage area, and receives a start notification signal transmitted in accordance with the first communication mode. The second wireless unit 200 performs wireless communications in the second communication mode for performing the communications in the second communication coverage area. The controller 300 starts the second wireless unit 200 on the basis of the received electric power of a start notification signal. The processing unit (upper signal processing unit) 400 manages or holds data transmitted or received by the first wireless unit 100 and the second wireless unit 200. The start notification signal is a signal, which is transmitted or received at the first wireless unit, for notifying a start of the second wireless unit.

The second wireless unit 200 of the first wireless apparatus 1 includes a timer 210 configured to measure the length of time which has passed since the second wireless unit 200 is started by the controller 300. Once the length of time measured by the timer 210 exceeds a certain length of time, the second wireless unit 200 stops its operation.

Portions of the first wireless apparatus 1 will be described below.

The first wireless unit 100 performs communications in the first communication mode, such as a wireless LAN communication mode, which has the first communication coverage area with a diameter of several meters. In response to a transmission request from the processing unit 400, the first wireless unit 100 performs transmission processing based on the first communication mode, and transmits data. To transmit transmission the data, the first wireless unit 100 transmits, via an antenna 10, the data (transmission data) received from the processing unit 400. In addition, at the time of receiving data, the first wireless unit 100 notifies the processing unit 400 of the received data, as well as creates and transmits an acknowledgment signal depending on the necessity.

In response to a request from the controller 300, the first wireless unit 100 transmits a start notification signal to the access point (AP) or broadcast a start notification signal. When receiving an acknowledge signal corresponding to the transmitted start notification signal, the first wireless unit 100 notifies the controller 300 of the reception of that signal. When receiving a start notification signal, the first wireless unit 100 notifies controller 300 of the reception of that signal.

The second wireless unit 200 performs communications in the second communication mode, such as the millimeter-band radio communication mode, which has the second communication coverage area with a diameter of several tens of centimeters. In response to a transmission request from the processing unit 400, the second wireless unit 200 performs transmission processing based on the second communication mode, and transmits data. To transmit the transmission data, the second wireless unit 200 transmits, via an antenna 20, the data (transmission data) received from the processing unit 400. In addition, at the time of receiving data, the second wireless unit 200 notifies the processing unit 400 of the received data, as well as creates and transmits an acknowledge signal depending on the necessity.

The second wireless unit 200 stops its operation and goes into the sleep mode if a certain length of time has passed since the last instruction from the controller 300, the start of the operation, or the finishing of the transmission/reception of data. In this case, all the power supply to the second wireless unit 200 may be stopped. Otherwise, the power supply to a part of the circuits included in the second wireless unit 200 may be stopped or reduced. For instance, only the power supply to an analog circuit (not illustrated) included in the second wireless unit 200 may be stopped. While in the sleep mode, the second wireless unit 200 is started in response to an instruction from the controller 300. The timer 210 included in the second wireless unit 200 measures the length of time which has passed since the second wireless unit 200 is started. Once the measured length of time exceeds a certain length, the timer 210 notifies the second wireless unit 200 of the fact.

The controller 300 controls the first and second wireless units 100, 200. The controller 300 makes control in order that the second wireless unit 200 can be started to perform communications in the second communication mode.

Specifically, in response to the transmission request from the processing unit 400, the controller 300 instruct the first wireless unit 100 to transmit a start notification signal, and thus starts the second wireless unit 200 from the sleep mode. The controller 300 instructs the second wireless unit 200 thus started to transmit a connection request signal. After the instruction, once the controller 300 receives a notification from the second wireless unit 200 of the fact that the second wireless unit 200 receives a connection accept signal, and then instructs the processing unit 400 to send data to the second wireless unit 200.

Once receiving a notification from the first wireless unit 100 of the reception of the start notification signal, the controller 300 starts the second wireless unit 200 from the sleep mode.

The processing unit 400 manages and holds the data that the first and second wireless units 100, 200 transmit or receive. The processing unit 400 has a queue (not illustrated), and transfers the data, which is held in the queue, to the first wireless unit 100 or the second wireless unit 200.

In this embodiment, the processing unit 400 is configured to determine whether data should be transmitted/received by the first wireless unit 1 or the second wireless unit 2. The method that the processing unit 400 can employ to determine which of the two wireless units should transmit/receive data are roughly threefold, as follows.

### (Method 1)

In a case where the processing unit 400 has a transmission queue (not illustrated) for the first wireless unit 100 and a transmission queue (not illustrated) for the second wireless unit 200, once data are inputted into the transmission queue for the second wireless unit 200, the processing unit 400 determines that the data should be transmitted/received by the second wireless unit 200.

### (Method 2)

Let us assume a case where the processing unit 400 has a transmission queue (not illustrated) which is shared between the first wireless unit 100 and the second wireless unit 200. While data are being transmitted/received by the first wireless unit 100, once a certain or larger amount of data directed to a wireless apparatus is accumulated in the transmission queue, the processing unit 400 determines that the second wireless unit 200 should be used for the communications with the wireless apparatus.

Let us assume the other case where the processing unit 400 has a transmission queue (not illustrated) which is shared between the first wireless unit 100 and the second wireless unit 200. While data is being transmitted/received by the first wireless unit 100, once data directed to a wireless apparatus are held in the transmission queue, the processing unit 400 determines that the second wireless unit 200 should be used for the communications with the wireless apparatus, irrespective of the amount of data held in the transmission queue.

Description will be hereinbelow given of the wireless apparatus by taking the case of the above-described method 1 as an example. No matter which of the three methods is employed, the wireless apparatus operates in the same manner as follows.

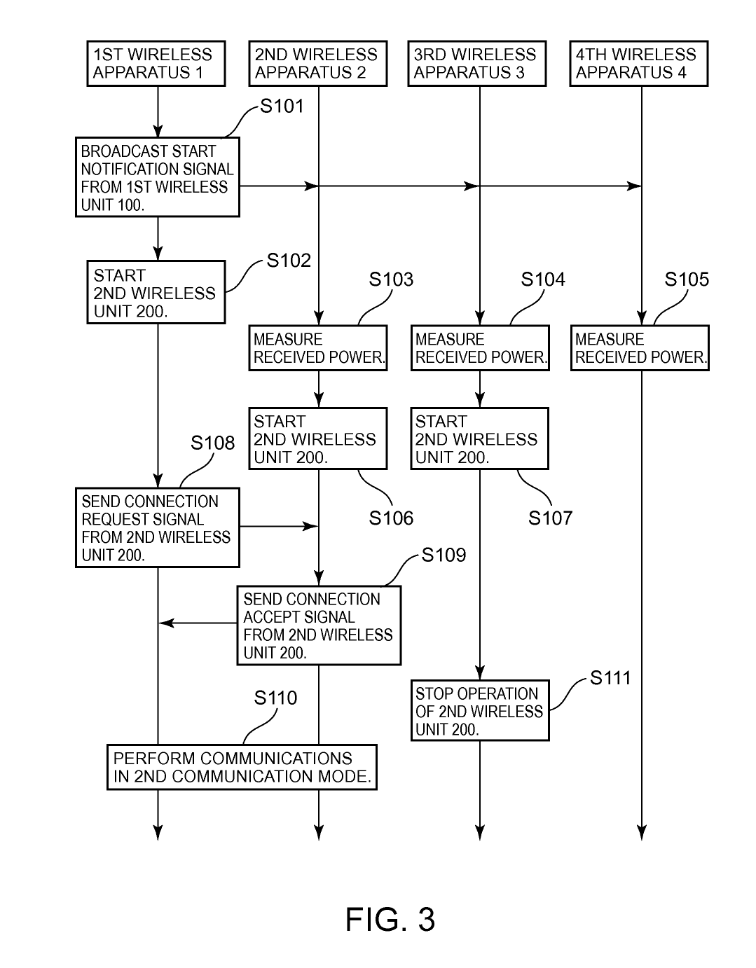

By use of FIGS. 3 to 5, description will be below provided for how the wireless system of this embodiment operates. FIG. 3 is a sequence diagram showing how the wireless system of this embodiment operates. The following description will be provided by taking, as an example, a case where the first and second wireless apparatuses shown in FIG. 1 communicate with each other in the second communication mode with the connection request signal transmitted by the first wireless apparatus 1 and the connection accept signal transmitted by the second wireless apparatus 2.

If the first wireless apparatus 1 determines that the communications be performed in the second communication mode, the first wireless apparatus 1 broadcasts a start notification signal from the first wireless unit 100 in the first communication mode (step S101), and thus starts the second wireless unit 200 (step S102).

Upon receiving the start notification signal, the second to fourth wireless apparatuses 2 to 4 measure the received power of the start notification signal (steps S103 to S105). In this respect, let us assume that the first to fourth wireless apparatuses 1 to 4 are placed as shown in FIG. 1. In this case, the received power of the start notification signal is the largest in the second wireless apparatus 2, and is the smallest in the fourth wireless apparatus 4.

The second to fourth wireless apparatuses 2 to 4 compare their respective received powers with a threshold TH1. Each of the second to fourth wireless apparatuses 1 to 4 starts its own second wireless unit 200, if the received power is larger than the threshold TH1. In this embodiment, let us assume that the received power is larger than the threshold TH1 in the second and third wireless apparatuses 2, 3 while the received power is smaller than the threshold TH1 in the fourth wireless apparatus 4. Accordingly, the second and third wireless apparatuses 2, 3 start their respective second wireless units 200, and wait for a connection request signal from the first wireless apparatus 1 (steps S106 S107). In contrast, the fourth wireless apparatus 4 does not start its own second wireless unit 200, but uses the first wireless unit 100 to perform communications in the first communication mode.

Once starting the second wireless unit 200, the first wireless apparatus 1 sends a connection request signal from the second wireless unit 200 in the second communication mode (step S108). As FIG. 1 shows, because the second wireless apparatus 2 exists within the second communication coverage area of the second communication mode of the first wireless apparatus 1, the second wireless apparatus 2 receives the connection request signal sent by the first wireless apparatus 1.

Upon receiving the connection request signal, the second wireless apparatus 2 checks whether or not the connection request is addressed to the second wireless apparatus 2. If the second wireless apparatus 2 determines that the connection request is addressed to the very second wireless apparatus 2 and that the communications with the first wireless apparatus 1 be performed in the second communication mode, the second wireless apparatus 2 sends a connection accept signal to the first wireless apparatus 1 (step S109). Once the first wireless apparatus 1 receives the connection accept signal, the first and second wireless apparatuses 1 2 perform communications in the second communication mode (step S110).

On the other hand, the third wireless apparatus 3 exists outside the second communication coverage area of the second communication mode of the first wireless apparatus 1. For this reason, the third wireless apparatus 3 does not receive the connection request signal sent by the first wireless apparatus 1. After waiting for a connection request signal for a certain length of time, the third wireless apparatus 3 stops the operation of the second wireless unit 200, and uses the first wireless unit 100 to perform communications in the first communication mode (step S111).

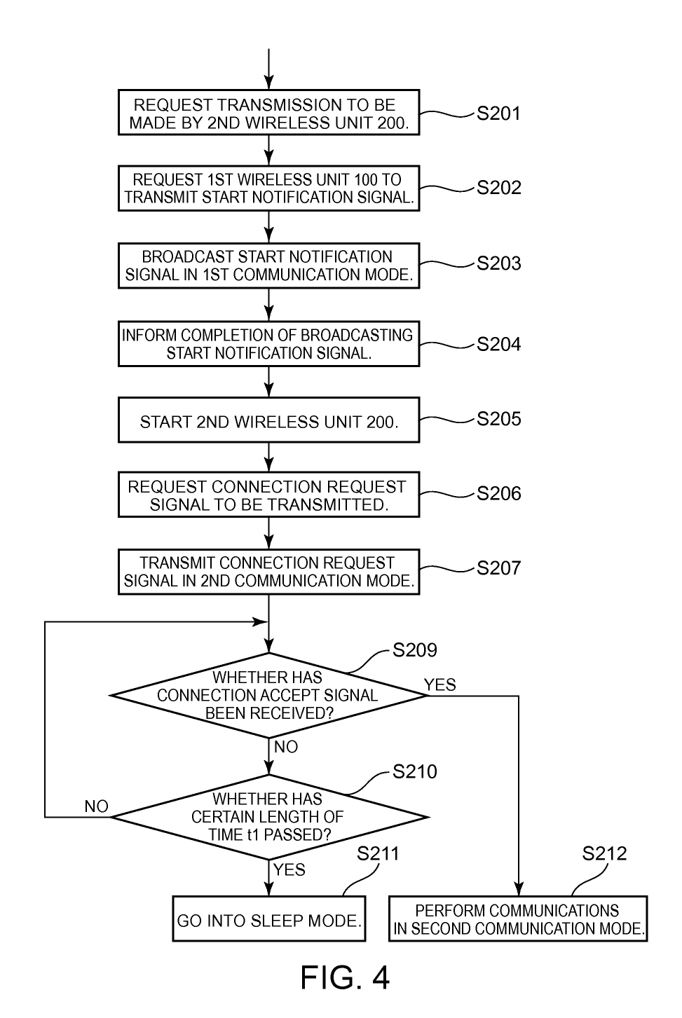

Next, the operation to be performed till the first wireless apparatus 1 starts the communications in the second communication mode will be described by referring to FIG. 4. Note that, if the processing unit 400 of each of the second to fourth wireless apparatuses 2, 4 starts communications in the second communication mode, each of the wireless apparatuses 2, 4 works similarly. For this reason, description for the wireless apparatuses 2 to 4 will be omitted.

If transmission data are inputted into the transmission queue for the second wireless unit 200, the processing unit 400 of the first wireless apparatus 1 requests the controller 300 to make the second wireless unit 200 transmit the data (step S201).

Upon receiving, from the processing unit 400, the request for the transmission to be made by the second wireless unit 200, the controller 300 requests the first wireless unit 100 to transmit a start notification signal in the first communication mode (step S202).

Upon receiving the request from the controller 300, the first wireless unit 100 broadcasts the start notification signal in the first communication mode (step S203). Having broadcasted the start notification signal, the first wireless unit 100 notifies the controller 300 of the broadcast completion (step S204).

Upon receiving the notification of the completion of broadcasting the start notification signal, the controller 300 starts the second wireless unit 200 (step S205), and requests the second wireless unit 200 to transmit a connection request signal to the destination of the data held in the transmission queue for the second wireless unit 200 in the processing unit 400 (step S206). In the following description, let us assume that the transmission queue for the second wireless unit 200 holds the data addressed to the second wireless apparatus 2.

The second wireless unit 200 transmits the connection request signal to the second wireless apparatus 2 in accordance with the second communication mode (step S207), and then waits for a connection accept signal to be sent back from the second wireless apparatus 2.

If the second wireless unit 200 receives the connection accept signal from the second wireless apparatus 2 (Yes in step S209), the second wireless unit 200 notifies the controller 300 of the reception. Upon receiving the notification from the second wireless unit 200, the controller 300 notifies the processing unit 400 of the reception. Upon receiving the notification from the controller 300, the processing unit 400 transfers the data held in the transmission queue for the second wireless unit 200 to the second wireless unit 200. The second wireless unit 200 performs communications with the second wireless apparatus 2 in the second communication mode by: transmitting, in the second communication mode, the transmission data received from the processing unit 400; and receiving ACK or BA (step S212).

The second wireless unit 200 makes the timer 210 measure the length of time T1 that has passed since the transmission of the connection request signal. If the second wireless unit 200 receives no connection accept signal (No in step S209), the second wireless unit 200 waits for the reception of the connection accept signal till the length of time T1 exceeds a certain length of time t1 (No in step S210). If the second wireless unit 200 receives no connection accept signal even though the length of time T1 exceeds the length of time t1 (Yes at step S210), the second wireless unit 200 stops its operation, notifies the controller 300 of the stopping of its operation, and thus goes into the sleep mode (step S211). Once the second wireless unit 200 goes into the sleep mode, the controller 300 informs the processing unit 400 that the communications be performed in the first communication mode.

If the processing unit 400 is notified that the second wireless unit 200 has gone into the sleep mode, the processing unit 400 may transmit the data held in the transmission queue for the second wireless unit 200 via the first wireless unit 100 in the first communication mode. Alternatively, the processing unit 400 may request the controller 300 to transmit the data via the second wireless mode after a certain interval.

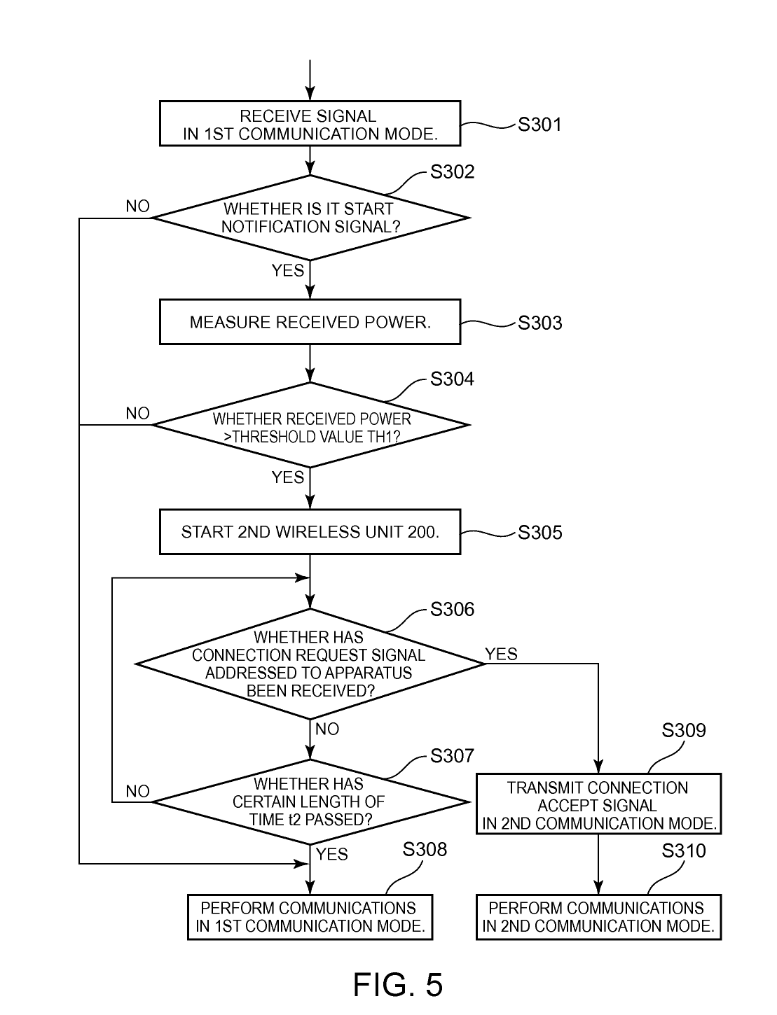

Using FIG. 5, description will be given of how the second to fourth wireless apparatuses 2 to 4 work. It should be noted that, once receiving the start notification signal in the first communication mode, the first to fourth wireless apparatuses 1 to 4 work in the same manner. For this reason, the following description will be provided for how the second wireless apparatus 2 works, and descriptions for the other wireless apparatuses will be omitted.

Let us assume that the second wireless apparatus 2 is currently performing communications in the first communication mode via the first wireless unit 100. In this case, the first wireless unit 100 receives a signal based on the first communication mode (step S301). The first wireless unit 100 demodulates the received signal, and judges whether or not the received signal is a start notification signal (step S302).

If the received signal is not the start notification signal (No in step S302), the first wireless unit 100 continues to perform communications in the first communication mode (step S308). In contrast, if the received signal is the start notification signal (Yes in step S302), the first wireless unit 100 notifies the controller 300 of the reception of the start notification signal, and measures the received power of the start notification signal (step S303). Subsequently, the first wireless unit 100 notifies the controller 300 of the measured received power.

The controller 300 compares a threshold TH1 with the received power of the start notification signal notified of by the first wireless unit 100 (step S304). If the received power is equal to or lower smaller than the threshold TH1 (No in step S304), the controller 300 determines that no communications in the second communication mode be performed, and does not start the second wireless unit 200. The first wireless unit 100 continues to perform communications in the first communication mode (step S308).

In contrast, if the received power is larger than the threshold TH1 (Yes in step S304), the controller 300 determines that the communications be performed in the second communication mode, and stars the second wireless unit 200 (step S305). The second wireless unit 200 thus started waits for the connection request signal. If the second wireless unit 200 receives the connection request signal (Yes in step S306), the second wireless unit 200 transmits a connection accept signal in the second communication mode as long as the connection request destination of the received connection request signal is the second wireless apparatus 2 (step S309).

The second wireless unit 200 notifies the controller 300 of the transmission of the connection accept signal. Upon receiving the notification, the controller 300 determines that communications be performed by use of the second wireless unit 200, and notifies the processing unit 400 of the determination. Thereafter, the second wireless unit 200 performs the communications in the second communication mode (step S310).

If the second wireless unit 200 receives no connection request signal addressed to the second wireless unit apparatus 2 (No in step S306), the second wireless unit 200 waits for the connection request signal till the length of time T1 measured by the timer 210 exceeds a certain length of time t2 (No in step S307). If the second wireless unit 200 receives no connection request signal before the length of time T1 exceeds the certain length of time t2 (Yes in step S307), the second wireless unit 200 stops its operation after notifying the controller 300 that the second wireless unit 200 is going into the sleep mode. Upon receiving the notification, the controller 300 determines that communications be performed in the first communication mode, and the first wireless unit 100 continues to perform communications in the first communication mode (step S308).

It should be noted that, for the threshold TH1 to be compared with the received power in step S304, the relationship between the received power of a signal received in the first communication mode and the second communication coverage area of the second communication mode may be stored in a memory (not illustrated) included in the controller 300. Alternatively, the second wireless apparatus 2 may set a small threshold TH1 at the beginning and adjust the threshold TH1 during performing communications, for example, by increasing the threshold TH1 gradually if the second wireless unit 200 receives no connection request signal in step S306 after starting at step S305. In addition, the certain length of time t2 for waiting for the connection request signal may be several times longer than each transmission interval determined for transmitting the connection request signal in the second communication mode. While the second wireless unit 200 is waiting for the connection request signal, it is not necessary to start all the functions of the second wireless unit 200. Rather, it suffices if at least the circuits needed to receive the connection request signal are started instead.

In addition, the transmission power of the start notification signal transmitted by the first wireless unit 100 may be set at a transmission power appropriate for the second communication coverage area. In this case, it is possible to start the second wireless unit 200 of the wireless apparatus that exists in the second communication coverage area. For instance, in the case shown in FIG. 3, only the second wireless unit 200 of the second wireless apparatus 2 can be started.

In the case shown in FIG. 4, the controller 300 starts the second wireless unit 200 after requesting the first wireless unit 100 to transmit the start notification signal. However, that the controller 300 may request the first wireless unit 100 to transmit the start notification signal after starting the second wireless unit 200.

As has been described thus far, the wireless system of this embodiment makes it possible to start or stop the operation of the second wireless unit 200 with the smaller communication coverage area by use of the first wireless unit 100 with the broader communication coverage area, and accordingly to reduce the power consumption of the second wireless unit 200. As long as communications can be performed using the second wireless unit 200, communications can be securely performed using the first wireless unit 100. Accordingly, in the case where, for instance, the second wireless unit 200 with the smaller communication coverage area is used to control the operation of the first wireless unit 100 with the broader communication coverage area, the first wireless unit 100 may be controlled depending solely upon whether or not the second wireless unit 200 is able to perform communications.

However, in the case of the wireless system of this embodiment in which the first wireless unit 100 with the broader communication coverage area is used to control the operation of the second wireless unit 200 with the smaller communication coverage area, the fact that the first wireless unit 100 can communicate with its communication counterpart does not means that the second wireless unit 200 can communicate with the communication counterpart of the first wireless unit 100 as well. Hence, if the reception of a start notification signal by the first wireless unit 100 automatically leads to the starting of the second wireless unit 200, the power consumption of the second wireless unit 200 can be reduced drastically. By contrast, this embodiment enables the second wireless unit 200 to be started under the condition that not only the start notification signal is received, but also the communication counterpart of the second wireless unit 200 exists within the second communication coverage area of the second wireless unit 200, which is confirmed by the comparison of the intensity of the received power of the start notification signal with the threshold. Thereby, this embodiment can reduce the power consumption of the second wireless unit 200 more.

### Second Embodiment

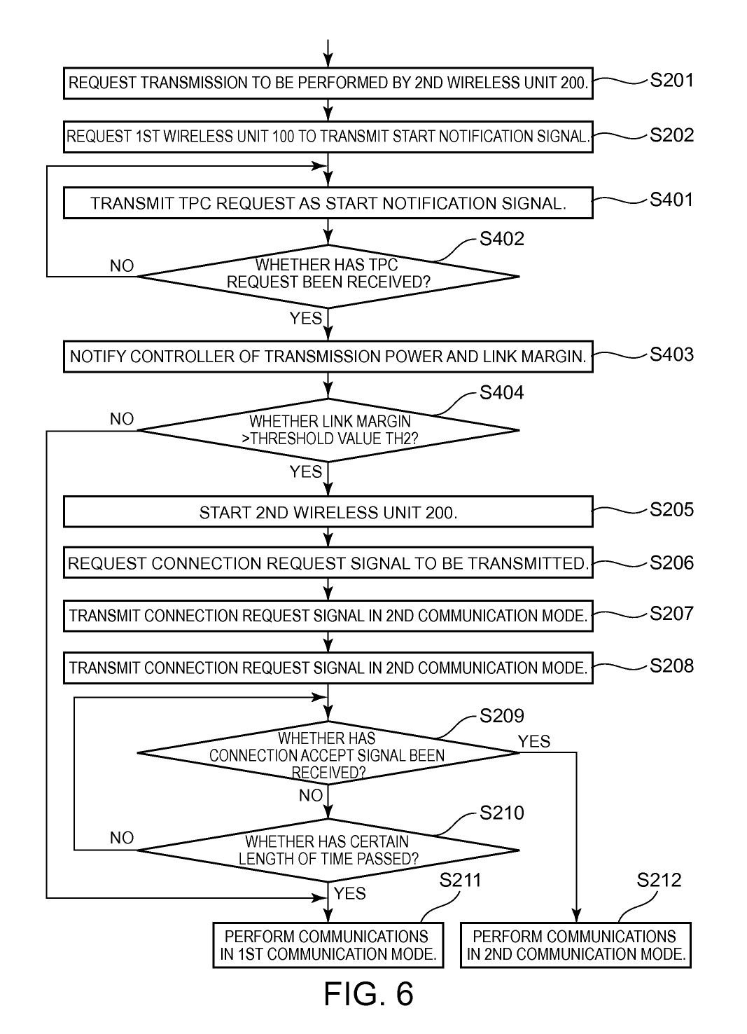

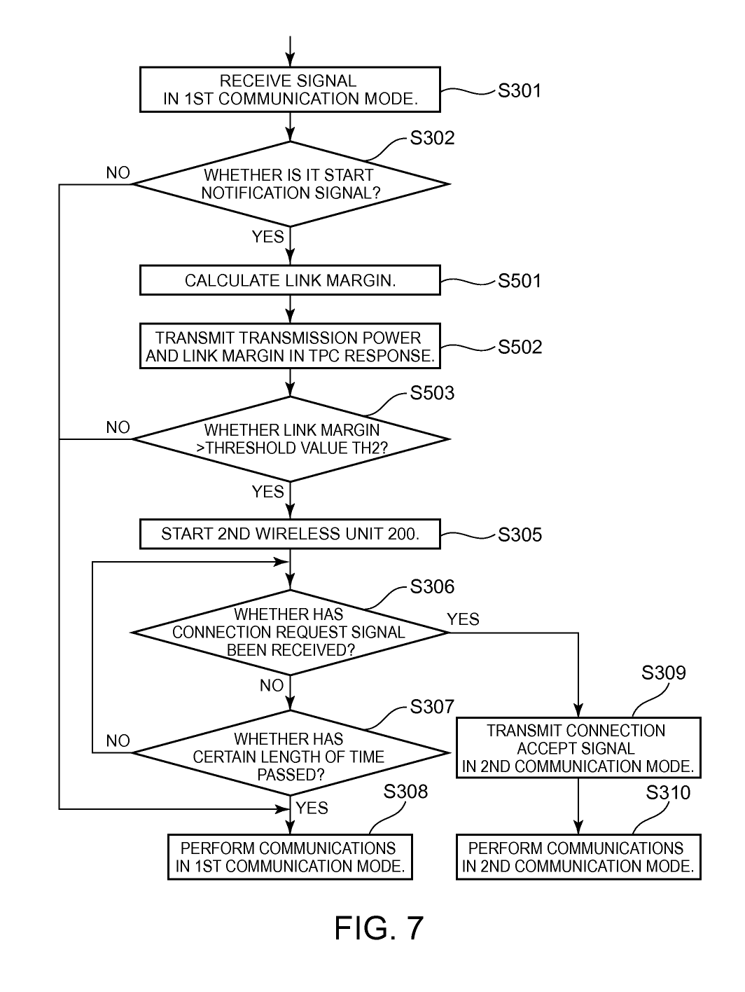

Next, a wireless system of a second embodiment of the invention will be described by referring to FIGS. 6 and 7. This embodiment differs from the first embodiment in that whether or not to start the second wireless unit 200 is determined by use of a link margin, but not the received power of the start notification signal. First to fourth wireless apparatuses 1 to 4 of this embodiment have the same configurations as do the wireless apparatuses shown in FIGS. 1 and 2. For this reason, portions of the wireless apparatuses 1 to 4 which are the same as those shown in FIGS. 1 and 2 are denoted by the same reference numerals used in FIGS. 1 and 2, and description of those portions will be omitted. The description of this second embodiment will be based on a case where the first and second wireless apparatuses 1, 2 shown in FIG. 1 perform communications with each other in the second communication mode with a connection request signal transmitted by the first wireless apparatus 1 and a connection accept signal sent back by the second wireless apparatus 2.

The operation of the first wireless apparatus 1 of this second embodiment will be described by referring to FIG. 6. Note that, if the processing unit 400 starts the communications in the second communication mode, the second to fourth wireless apparatuses 2 to 4 operate similarly. In addition, the operation to be performed till step S202 is the same as that shown in FIG. 4.

If receiving, from controller 300, a request for a start notification signal to be transmitted, the first wireless unit 100 transmits the start notification signal in the first communication mode. The first wireless unit 100 of this second embodiment transmits a TPC request as the start notification signal (step S401). The TPC request transmitted by the first wireless unit 100 includes a notification requesting information on the transmission power of the wireless apparatus that receives the request and the link margin.

If receiving a TPC response that is a reply to the TPC request having been sent in step S401 (Yes in step S402), the first wireless unit 100 notifies the controller 300 of the information on the transmission power and the link margin which is included in the TPC response (step S403). On the other hand, if receiving no TPC response for a certain length of time (No at step S402), the first wireless unit 100 may go back to step S401, where the first wireless unit 100 transmits a TPC request again.

If receiving the information on the transmission power and the link margin of the wireless apparatus that has transmitted the TPC response, the controller 300 determines whether or not to start the second wireless unit 200 on the basis of the magnitude of the link margin. To this end, the controller 300 compares the link margin with a threshold TH2. If the link margin is equal to or smaller than the threshold TH2 (No in step S404), the controller 300 determines that: the second wireless unit 200 should not be started; and communications in the first communication mode should be performed using the first wireless unit 100. In accordance with the determination made by the controller 300, the first wireless unit 100 continues to perform communications in the first communication mode (step S211).

On the other hand, if the link margin is larger than the threshold TH2 (Yes in step S404), the controller 300 starts the second wireless unit 200 (step S205). The operation in step S205 and the ensuring steps is the same as that shown in FIG. 4. For this reason, description for the operation will be omitted.

Next, using to FIG. 7, descriptions will be provided for how the second wireless apparatus 2 operates. Note that the first to the fourth wireless apparatuses 1 to 4 operate similarly if they receive the start notification signal in the first communication mode. In addition, the operation to be performed till the reception of the start notification signal is the same as that shown in FIG. 4. For this reason, description for the operation will be given below.

If the signal received by the first wireless unit 100 of the second wireless apparatus 2 is a start notification signal (Yes at step S302), the first wireless unit 100 of the second wireless apparatus 2 calculates the transmission power and the link margin in response to a request for information on the transmission power and the link margin which is included in the TPC request as the start notification signal (step S501).

The first wireless unit 100 notifies the controller 300 of the information on the transmission power and the link margin which are calculated at step S501. In addition, the first wireless unit 100 transmits a TPC response including the information to the first wireless apparatus 1 (step S502).

The controller 300 determines whether or not to start the second wireless unit 200 on the basis of the magnitude of the link margin. To this end, the controller 300 compares the link margin with a threshold TH2. If the link margin is equal to or smaller than the threshold TH2 (No in step S503), the controller 300 determines that: the second wireless unit 200 should not be started; and communications in the first communication mode should be performed using the first wireless unit 100. In accordance with the determination made by the controller 300, the first wireless unit 100 continues to perform communications in the first communication mode (step S308).

On the other hand, if the link margin is larger than the threshold TH2 (Yes in step S503), the controller 300 starts the second wireless unit 200 (step S305). The operation in step S205 and the ensuring steps is the same as that shown in FIG. 5. For this reason, description for the operation will be omitted.

The first wireless unit 100 of the second wireless apparatus 2 transmits the TPC response once calculating the transmission power and the link margin. However, the first wireless unit 100 may transmit the TPC response after the controller 300 determines that the second wireless unit 200 be started. In this case, the TPC response may include information on whether or not the second wireless unit 200 is started, that is to say, whether or not to perform communications in the second communication mode, instead of including information on the transmission power and the link margin.

As has been described thus far, the wireless system of this second embodiment can obtain the same effects as can the wireless system of the first embodiment. In addition, the wireless system of this second embodiment can determine whether or not the first wireless apparatus 1 starts its own second wireless unit 200 on the basis of the information on the transmission power or on the link margin. Accordingly, even if the communications in the second communication mode are requested by the first wireless apparatus 1, the power consumption of the second wireless unit 200 of the first wireless apparatus 1 can be reduced.

### Third Embodiment

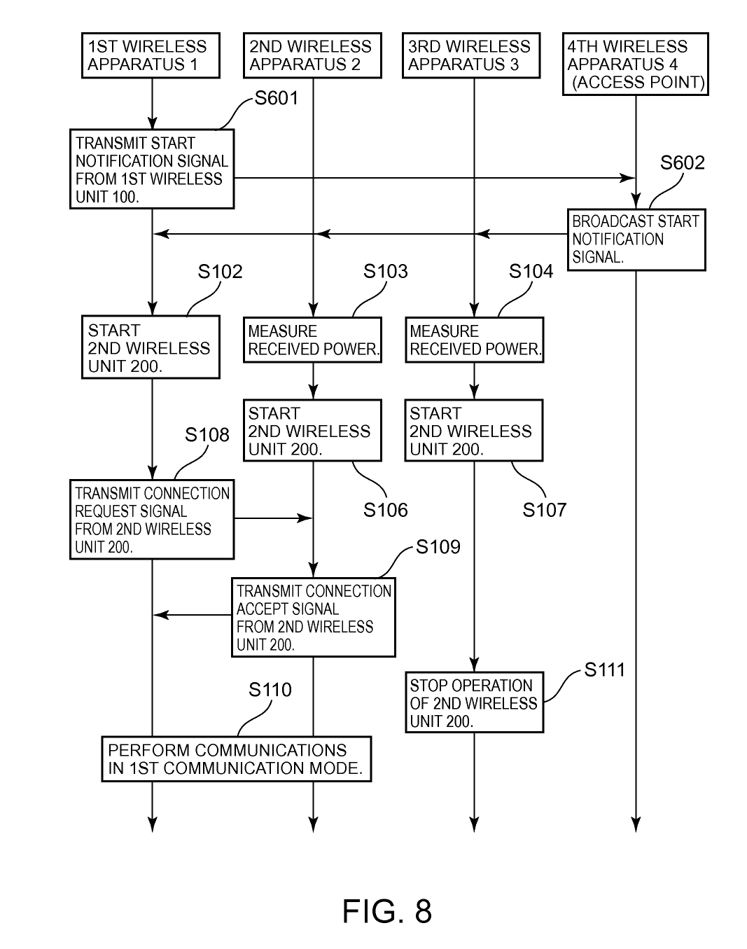

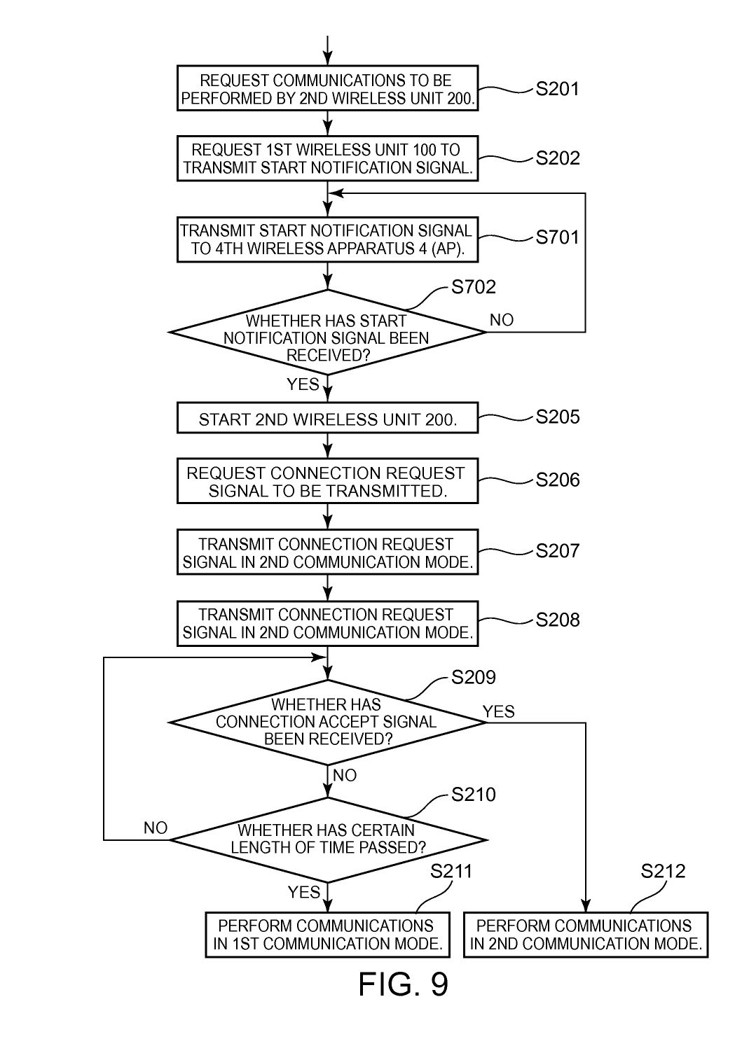

Using FIGS. 8 and 9, descriptions will be provided for a wireless system of a third embodiment of the invention. First to fourth wireless apparatuses 1 to 4 of this embodiment have the same configurations as do the wireless apparatuses shown in FIGS. 1 and 2. For this reason, portions of the wireless apparatuses 1 to 4 which are the same as those shown in FIGS. 1 and 2 are denoted by the same reference numerals used in FIGS. 1 and 2, and description of those portions will be omitted. The wireless system of this embodiment performs communications by way of an access point as in the cases of, for instance, wireless LANs. The following description of this third embodiment will be given by assuming that the fourth wireless apparatus 4 shown in FIG. 1 functions as an access point.

FIG. 8 is a sequence diagram showing how the wireless system of this third embodiment operates. The description of this embodiment will be based on a case where the first and second wireless apparatuses 1, 2 shown in FIG. 1 perform communications with each other in the second communication mode with a connection request signal transmitted by the first wireless apparatus 1 and a connection accept signal sent back by the wireless apparatus 2.

If determining that communications be performed in the second communication mode, the first wireless apparatus 1 causes the first wireless unit 100 to transmits a start notification signal in the first communication mode to the fourth wireless apparatus 4 serving as an access point (step S601).

If receiving the start notification signal from the first wireless apparatus 1, the fourth wireless apparatus 4 broadcasts the start notification signal to the first to third wireless apparatuses 1 to 3 (step S602).

If receiving the start notification signal broadcasted by the fourth wireless apparatus 4, the first wireless apparatus 1 starts its own second wireless unit 200 (step S102).

The operation in step S205 and the ensuring steps is the same as that shown in FIG. 3. For this reason, description for the operation will be omitted.

Next, using FIG. 9, descriptions will be provided for how the first wireless apparatus 1 operates until starting communications in the second communication mode. Note that the second to fourth wireless apparatuses 1 to 4 operate similarly if they start communications in the second communication mode. In addition, the operation to be performed till the reception of the start notification signal is the same as that shown in FIG. 4. For this reason, description for the operation will be given below.

If receiving, from the controller 300, a request for a start notification signal to be transmitted, the first wireless unit 100 transmits the start notification signal to the fourth wireless apparatus 4 serving as an access point in accordance with the first communication mode (step S701).

If receiving the start notification signal broadcasted by the fourth wireless apparatus 4 (Yes in step S702), the first wireless unit 100 notifies the controller 300 of the reception of the start notification signal. Upon receiving the notification, the controller 300 starts the second wireless unit 200 (step S205). The operation to be performed in step S205 and the ensuing steps is the same as that shown in FIG. 4. For this reason, description for the operation will be omitted.

If, after the transmission of the start notification signal to the fourth wireless apparatus 4, the first wireless unit 100 receives, for a certain length of time, no start notification signal broadcasted by the fourth wireless apparatus 4 (No at step S702), the first wireless unit 100 may transmit the start notification signal to the fourth wireless apparatus 4 again.

As has been described thus far, the wireless system of this embodiment can reduce the power consumption of the second wireless units of the wireless apparatuses as in the case of the first embodiment.

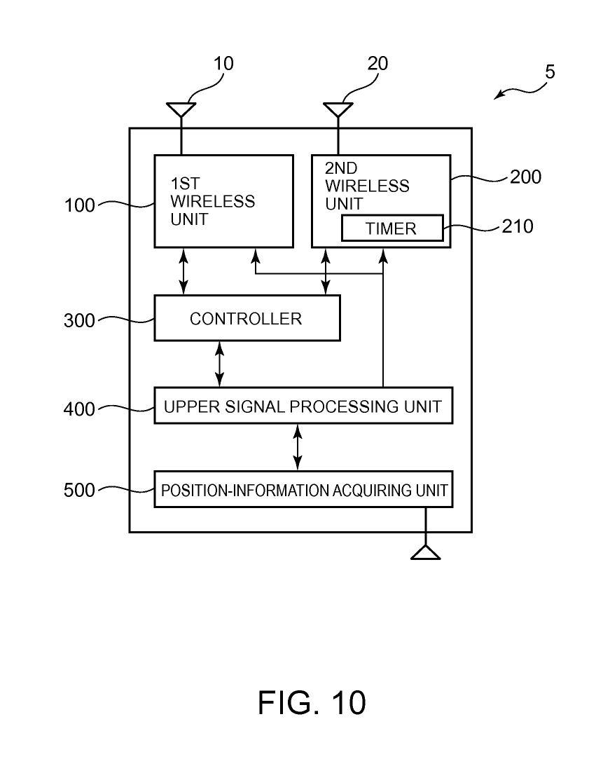

Using FIGS. 10 to 13, description will be provided for a wireless system of a fourth embodiment of the invention. The wireless apparatuses of this embodiment are different from the wireless apparatuses of the first embodiment in that each of the wireless apparatuses of this embodiment includes a location-information acquiring unit 500. The wireless system of this embodiment includes first to fourth wireless apparatuses 11 to 14.

FIG. 10 is a diagram showing the configuration of the wireless apparatuses of this fourth embodiment. Since all of the first to fourth wireless apparatuses 11 to 14 are identical to each other, the following description will be provided for the first wireless apparatus 11.

The first wireless apparatus 11 shown in FIG. 10 has the same configuration as does the first wireless apparatus 11 shown in FIG. 2, except that that shown in FIG. 10 includes a location-information acquiring unit 500.

The location-information acquiring unit 500 is, for instance, a GPS receiver, and acquires information on the location of the first wireless apparatus 11 by means of an antenna 50. The location-information acquiring unit 500 transfers the acquired location information to the processing unit 400. The location-information acquiring unit 500 acquires the location information in response to a notification sent by the processing unit 400.

In the above-described case, the first wireless apparatus 1 includes the location-information acquiring unit 500. Instead, however, either of the first wireless unit 100 or the second wireless unit 200 may additionally perform the function of the location-information acquiring unit 500. In addition, the location-information acquiring unit 500 may transfer the acquired location information to the controller 300, but not to the processing unit 400.

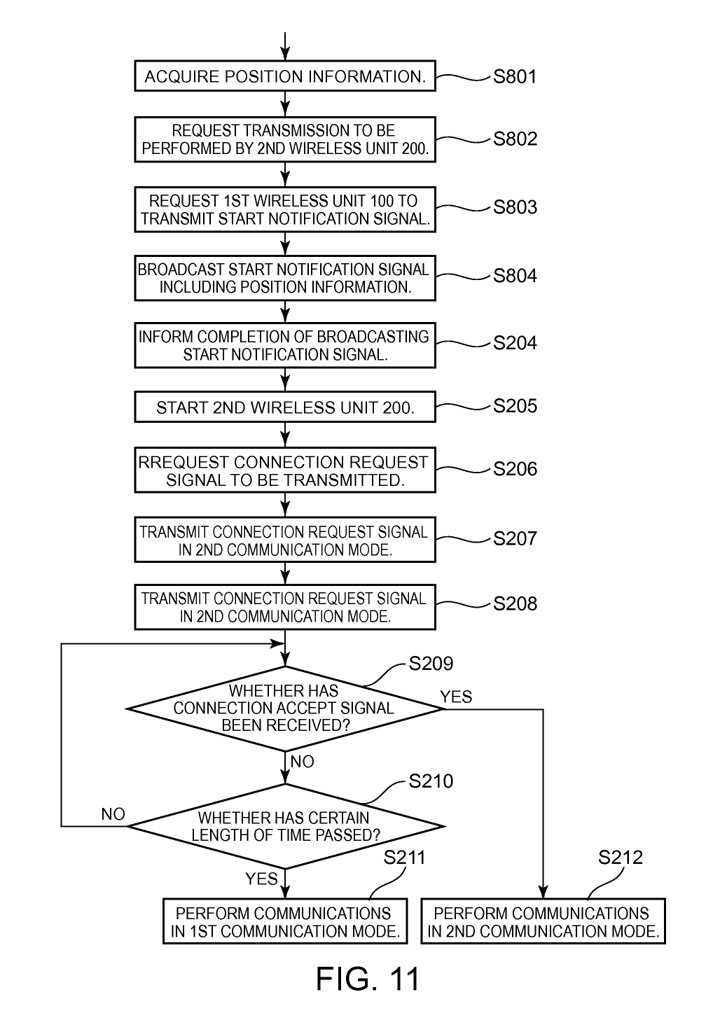

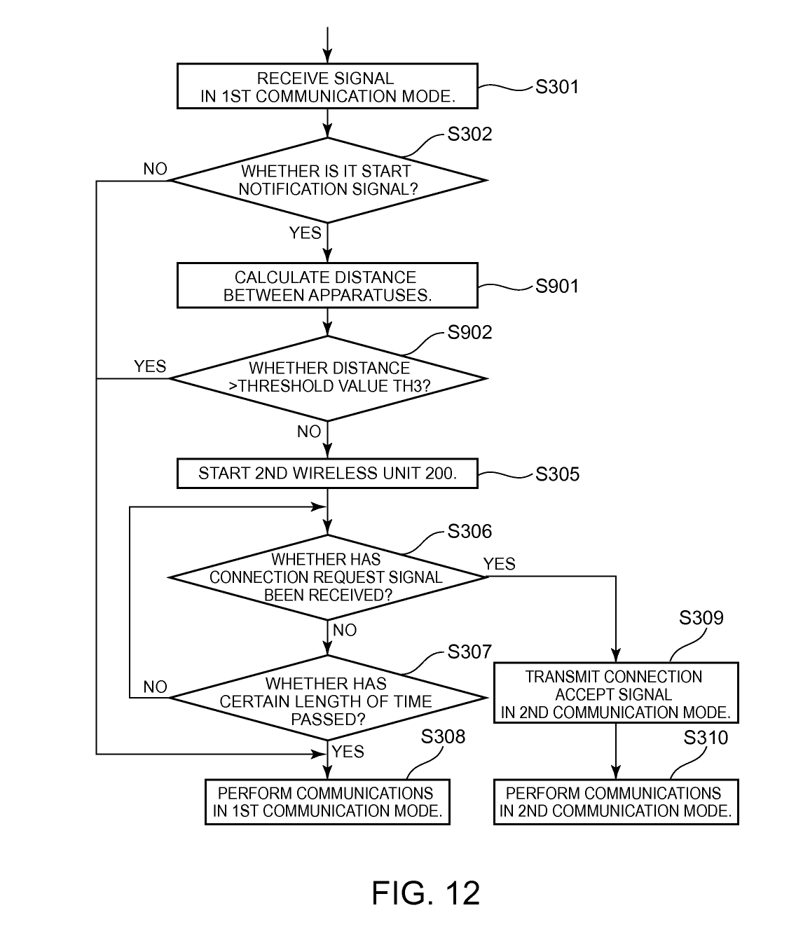

Next, using FIGS. 11 and 12, description will be provided for how the wireless system of this embodiment operates. The following description will be provided based on the case where the first and second wireless apparatuses 11 and 12 communicate with each other with a connection request signal transmitted by the first wireless unit 11 and a connection accept signal sent back by the second wireless apparatus 12.

FIG. 11 is a flowchart showing how the first wireless apparatus 11 operates. Note that, if the processing unit 400 starts the communications in the second communication mode, the second to the fourth wireless apparatuses 12 to 14 operate similarly.

If determining that the transmission be performed by the second wireless unit 200, the processing unit 400 sends a notification to the location-information acquiring unit 500, requesting the acquisition of the information on the current location of the first wireless apparatus 11. Upon receiving the notification, the location-information acquiring unit 500 acquires the location information, and transfers the acquired location information to the processing unit 400 (step S801).

Upon receiving the location information, the processing unit 400 requests the controller 300 to perform transmission by use of the second wireless unit 200, and transfers the location information to the controller 300 (step S802). The controller 300 requests the first wireless unit 100 to transmit, in the first communication mode, a start notification signal including the location information (step S803). The first wireless unit 100 broadcasts the start notification signal including the location information (step S804). The operation in step S804 and the ensuing steps is the same as that shown in FIG. 4. For this reason, description for the operation will be omitted.

FIG. 12 is a flowchart showing how the second wireless unit 12 operates. Note that the first to fourth wireless apparatuses 11 to 14 operate similarly if they receive the start notification signal in the first communication mode. The operation to be performed until receiving the start notification signal is the same as that shown in FIG. 4. For this reason, description for the operation will be omitted.

If the received signal is the start notification signal (Yes at step S302), the first wireless unit 100 of the second wireless apparatus 12 sends a notification requesting location information to the controller 300. The controller 300 requests the processing unit 400 to acquire the location information. The processing unit 400 sends a notification requesting the location-information acquiring unit 500 to acquire location information, and then the location-information acquiring unit 500 transfers the acquired location information to the processing unit 400. The processing unit 400 transfers, to the controller 300, the location information received from the location-information acquiring unit 500. The controller 300 calculates the distance between the first and second wireless apparatuses 11, 12 on the basis of the information received from the processing unit 400 on the location of the second wireless apparatus 12 and the information received from the first wireless unit 100 on the location of the first wireless apparatus 11 (step S901).

The controller 300 determines whether or not to start the second wireless unit 200 on the basis of the distance between the first and second wireless apparatuses 11, 12. The controller 300 compares the distance between the first and second wireless apparatuses 11, 12 with a threshold TH3. If the distance is larger than the threshold TH3 (Yes in step S902), the controller 300 determines that: the second wireless unit 200 should not be started; and communications in the first communication mode should be performed using the first wireless unit 100. In accordance with the determination made by the controller 300, the first wireless unit 100 continues to perform communications in the first communication mode (step S308).

On the other hand, if the distance is equal to or smaller than the threshold TH3 (No in step S902), the controller 300 starts the second wireless unit 200 (step S305). The operation in step S305 and the ensuring steps is the same as that shown in FIG. 5. For this reason, description for the operation will be omitted.

In the above-described case, the first wireless apparatus 11 starts the second wireless unit 200 after transmitting the start notification signal. However, a scheme may be adopted in which: the second wireless apparatus 12 transmits the calculated distance between the first and second wireless apparatuses 11, 12 to the first wireless apparatus 11; and then the first wireless apparatus 11 starts the second wireless unit 200 on the basis of the distance.

As has been described thus far, the wireless system of this embodiment can obtain the effects as can the wireless system of the first embodiment. In addition, the calculation of the distance between the first and second wireless apparatuses 11, 12 by use of the location information makes it possible to make more reliable judgment concerning whether or not the second wireless apparatus 12 exists within the second communication coverage area of the first wireless apparatus 11. Accordingly, it is less frequently that the wireless system of this embodiment erroneously starts the second wireless unit 200 of the wireless apparatus located outside the second communication coverage area. Thus, the power consumption of the second wireless unit 200 can be reduced more.

The description of this embodiment is based on the case where: the location-information acquiring unit 500 is added to each wireless apparatus of the wireless system of the first embodiment; and where the judgment concerning whether or not to start the second wireless unit 200 is made using the location information instead of the received power. Similarly, the location information may be used for the third embodiment. Furthermore, instead of the transmission power and the link margin in the second embodiment, the location information may be used to make the judgment concerning whether or not to start the second wireless unit 200.

### Fifth Embodiment

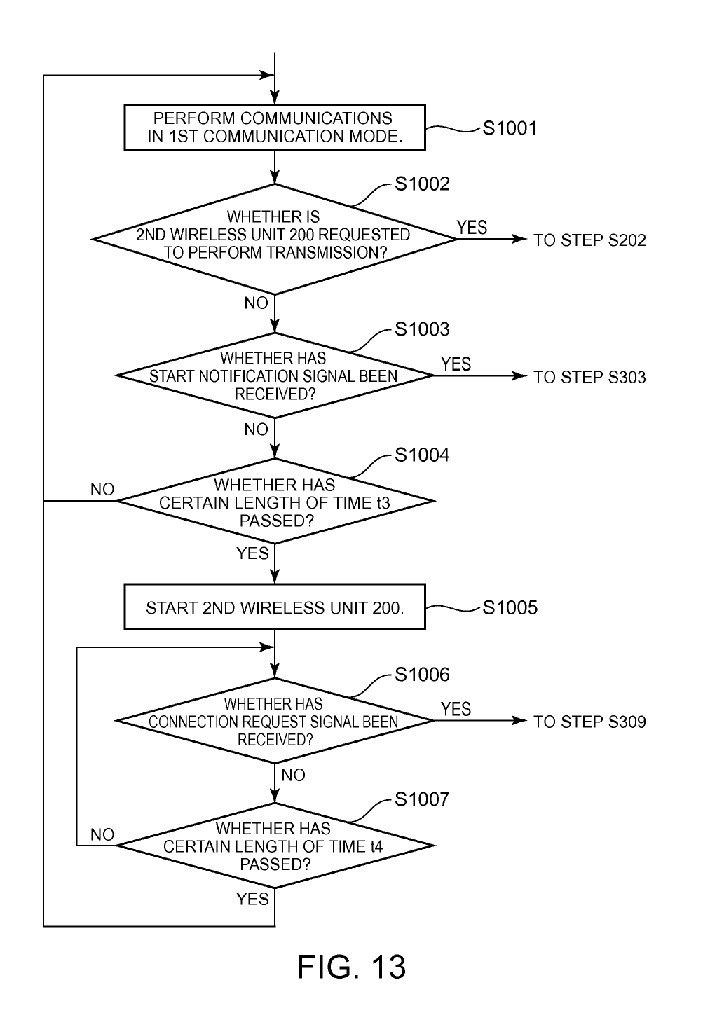

Next, using FIG. 13, description will be provided for a wireless system of a fifth embodiment of the invention. This fifth embodiment differs from the first embodiment in that, while communications are being performed in the first communication mode, the second wireless unit 200 performs reception operations for a certain length of time at certain intervals. First to fourth wireless apparatuses 1 to 4 of this embodiment have the same configurations as do the wireless apparatuses shown in FIGS. 1 and 2. For this reason, portions of the wireless apparatuses 1 to 4 which are the same as those shown in FIGS. 1 and 2 are denoted by the same reference numerals used in FIGS. 1 and 2, and description of those portions will be omitted. The description of this embodiment will be based on a case where the first and second wireless apparatuses 1, 2 shown in FIG. 1 perform communications with each other in the second communication mode with a connection request signal transmitted by the first wireless apparatus 1 and a connection accept signal sent back by the second wireless apparatus 2.

Using FIG. 13, description will be provided for how the first wireless apparatus 1 of this embodiment operates. Note that the second to fourth wireless apparatuses 2 to 4 operate similarly.

If, while the first wireless unit 100 of the first wireless apparatus 1 is performing communications in the first communication mode (step S1001), a request comes from the processing unit 400, requesting that transmission be performed by use of the second wireless unit 200 (Yes in step S1002), the operation in step S202 and the ensuing steps shown in FIG. 4 are performed. If no transmission request comes from the processing unit 400 (No in step S1002), and furthermore if the first wireless unit 100 receives a start notification signal (Yes in step S1003), the first wireless apparatus 1 performs the operation in step S303 and the ensuing steps shown in FIG. 5.

If no transmission request comes from the processing unit 400 (No in step S1002), and if the first wireless unit 100 does not receive the start notification signal (No in step S1003), and furthermore if a certain length of time t3 has passed (Yes in step S1004), the controller 300 of the first wireless apparatus 1 starts the second wireless unit 200 (step S1005).

If the second wireless unit 200 receives a connection request signal (Yes in step S1006), the first wireless apparatus 1 performs the operations in step S309 and the ensuing steps shown in FIG. 5. If the second wireless unit 200 does not receive the connection request signal (No in step S1006), and, in addition, if a certain length of time t4 has passed (Yes in step S1007), the second wireless unit 200 stops its operations, and the first wireless apparatus 1 performs communications in the first communication mode using the first wireless unit 100.

As has been described thus far, the wireless system of this embodiment can obtain the same effects as can the wireless system of the first embodiment. In addition, the reception operations performed for a certain length of time t4 at regular intervals t3 enables the communications to be performed in the second communication mode even when the communication counterpart cannot perform communications in the first communication mode.

The description of this embodiment is based on a case where the wireless apparatuses identical to the wireless apparatuses of the first embodiment make the second wireless unit 200 wait for a connection request signal at regular intervals t3. However the wireless apparatuses of the second to fourth embodiments may be configured to operate in the same manner.

Some embodiments of the invention have been described, but the embodiments described above are provided only as instances of the invention. No restriction is intended to be imposed on the scope of the invention. The novel embodiments may be carried out in various other forms. Various omissions, replacements, and modifications may be made without departing from the spirit of the invention. The embodiments and such other various modified forms are included both in the scope and spirit of the invention, and in the scope of the invention disclosed in the claims and their equivalents.

What is claimed is:

1. A wireless apparatus comprising:
a first wireless unit configured to perform wireless communications in a first communication mode for performing the communications within a first communication coverage area, and to receive a start notification signal transmitted in accordance with the first communication mode;
a second wireless unit configured to perform wireless communications in a second communication mode for performing the communications within a second communication coverage area which is smaller than the first communication coverage area;
a controller configured to start the second wireless unit on the basis of a received power of the start notification signal; and
a processing unit configured to manage or hold data transmitted and received by the first wireless unit and the second wireless unit.

2. The wireless apparatus according to claim 1, wherein
the controller starts the second wireless unit if a strength of the received power has a larger intensity than a threshold.

3. The wireless apparatus according to claim 1, wherein
the controller starts the second wireless unit if a link margin calculated based on the received power is equal to or larger than a threshold.

4. The wireless apparatus according to claim 1, wherein
the second wireless unit includes a timer configured to measure an elapsed length of time after the starting of the second wireless unit by the controller, and
if the length of time measured by the timer exceeds a predetermined length of time, the second wireless unit stops an operation.

5. The wireless apparatus according to claim 4,
wherein the predetermined length of time is equal to or longer than a transmission interval of a connection request signal in the second communication mode.

6. The wireless apparatus according to claim 1,
wherein the second wireless unit performs a reception operation for a length of time at regular intervals while the second wireless unit is not in operation.

7. A wireless apparatus comprising:
a first wireless unit configured to perform wireless communications in a first communication mode for performing the communications within a first communication coverage area, and to receive a start notification signal transmitted in accordance with the first communication mode;
a second wireless unit configured to perform wireless communications in a second communication mode for performing the communications within a second communication coverage area that is smaller than the first communication coverage area;
a controller configured to start the second wireless unit on the basis of location information included in the start notification signal; and
a processing unit configured to manage or hold data transmitted and received by the first wireless unit and the second wireless unit.

8. The wireless apparatus according to claim 7, wherein
based on the location information included in the start notification signal and the location information of the wireless apparatus, the controller calculates a distance between the wireless apparatus and a transmission destination apparatus having transmitted the start notification signal, and
if the distance falls within the second communication coverage area, the controller starts the second wireless unit.

9. The wireless apparatus according to claim 8, wherein
the second wireless unit includes a timer configured to measure an elapsed length of time after the starting of the second wireless unit by the controller, and
if the length of time measured by the timer exceeds a predetermined length of time, the second wireless unit stops an operation.

10. The wireless apparatus according to claim 9,
wherein the predetermined length of time is equal to or longer than a transmission interval of a connection request signal in the second communication mode.

11. The wireless apparatus according to claim 10,
wherein the second wireless unit performs a reception operation for a length of time at regular intervals while the second wireless unit is not in operation.

12. A wireless apparatus comprising:
a first wireless unit configured to perform wireless communications in a first communication mode for performing the communications within a first communication coverage area;
a second wireless unit configured to perform wireless communications in a second communication mode for performing the communications within a second communication coverage area that is smaller than the first communication coverage area;
a processing unit configured to manage or hold data transmitted and received by the first wireless unit and the second wireless unit; and
a controller configured to control the first wireless unit to transmit a start notification signal in accordance with the first communication mode in the case of transmitting the data held by the processing unit in the second communication mode, and to control the second wireless unit to transmit a connection request signal in accordance with the second communication mode after the first wireless unit transmits the start notification signal.

13. The wireless apparatus according to claim 12, wherein
the first wireless unit performs communications with an access point in the first communication mode, and transmits the start notification signal to the access point, and
if the first wireless unit receives a signal from the access point after transmitting the start notification signal, the controller controls the second wireless unit to transmit the connection request signal.
